(19) United States
(12) Patent Application Publication
(10) Pub. No.: US 2015/0355525 A1
(43) Pub. Date: Dec. 10, 2015

(54) LED CELLULAR PHONE SELF-IMAGERY ENHANCEMENT DEVICE

(71) Applicant: Craig Andrew Abrams, Los Angeles, CA (US)

(72) Inventor: Craig Andrew Abrams, Los Angeles, CA (US)

(21) Appl. No.: 14/735,087

(22) Filed: Jun. 9, 2015

Related U.S. Application Data
(60) Provisional application No. 61/996,010, filed on Jun. 9, 2014.

(51) Int. Cl. G03B 15/02; F21V 23/04; H04M 1/02; H04N 7/14; H04N 1/00; F21L 4/00; F21V 21/08

(52) U.S. Cl. CPC G03B 15/02; F21L 4/00; F21V 23/0414; F21V 21/08; H04N 7/142; H04N 1/00307; H04M 1/0264; F21Y 2101/02

(57) ABSTRACT

An audio jack coupled light-emitting device comprising a body comprising a front portion and a rear portion, the front portion comprises a first opening, the rear portion comprises a second opening, a power source located inside the body comprising one or more lithium ion batteries, a circuit board comprising a front and a rear surface located inside the body, a light-emitting element coupled to the front surface of the circuit board, an optical lens inside the first opening and in front of the light-emitting element, an audio plug, a dimmer switch coupled to the rear surface of the circuit board and the light-emitting element, a push button for turning the light-emitting element on and off, a push button cover for triggering the push button, and a timer for turning the light-emitting element off after a predetermined amount of time.

### CROSS-REFERENCE TO RELATED APPLICATIONS

The present application claims the benefit of U.S. Provisional Patent Application No. 61/996,010 titled “LED Cellular Phone Self Imagery Enhancement Device,” filed Jun. 9, 2014, the contents of which are incorporated in this disclosure by reference in their entirety.

### BACKGROUND OF THE INVENTION

With the rapid development of computer and communications technology, personal electronic products have become increasingly popular. Mobile telephones, or cellular phones (“cell phones”), have become one of the essential devices of people throughout the world. At the same time, the industry continues to introduce new mobile phones with various functions for enhancing the convenience and practicality of mobile phones. For example, smart phones have become the market mainstream, and the all-inclusive applications won the love of consumers. Smart phones are cell phones that perform many of the functions of a computer, typically having a touchscreen interface, Internet access, and an operating system capable of running downloaded applications. Smart phones also have a built-in flash for photography.

Currently, there is a popular trend of a user taking a photograph of himself or herself using his or her cell phone. These self-photographs have been affectionately termed “selfies.” However, a user takes his or her selfie in many different environments, and the ambient lighting is not always ideal for photographs. A user must therefore rely on the built-in flash from the cell phone for an additional source of light. This is problematic because the built-in flash only provides non-adjustable quick flashes of light, and does not provide a constant light source while taking the photograph. This can make it extremely difficult to take a flattering selfie as the flash is typically much too bright and washes out the user's face in the photograph. Furthermore, the built-in flash from the cell phone is a drain on the cell phone's battery.

As such, there is a need for a compact, energy efficient, adjustable, and easy to use device that provides a constant light source while a selfie is being taken.

U.S. Pat. No. 8,611,564 to Yen et al. teaches an audio jack coupled laser pointer, which does not provide an adequate light source for photographs. U.S. Pat. No. 6,341,871 to Angelopoulos, U.S. Pat. No. 6,755,549 to Rogers et al., U.S. Pat. No. 7,086,748 to Elembaby, and US2006/0014564 to Kung all teach lighting units that act as a flashlight for the user. They do not provide a suitable light source for use with taking photographs. Moreover, most of the devices draw their power from the electronic device they are coupled to, and do not comprise their own power source.

The present invention overcomes several of the deficiencies, disadvantages and undesired parameters associated with known audio jack coupled light-emitting devices.

### SUMMARY OF THE INVENTION

According to one embodiment of the present invention, there is provided an audio jack coupled light-emitting device comprising a body comprising a front portion and a rear portion, wherein the front portion comprises a first opening and the rear portion comprises a second opening, a power source located inside the body, the power source comprising one or more lithium ion batteries, a circuit board comprising a front surface and a rear surface, wherein the circuit board is located inside the body, a light-emitting element coupled to the front surface of the circuit board, an optical lens inside the first opening in the front portion of the body and in front of the light-emitting element, an audio plug comprising a cone body, a middle portion, and a rear end portion, a dimmer switch coupled to the rear surface of the circuit board and the light-emitting element, a push button for turning the light-emitting element on and off, a push button cover for triggering the push button, and a timer for turning the light-emitting element off after a predetermined amount of time.

In another embodiment of the invention, there is provided an audio jack coupled light-emitting device comprising, a body, a power source located inside the body, a circuit board located inside the body, a light-emitting element coupled to the circuit board, an audio plug coupled to the body, a dimmer switch coupled to the circuit board and the light-emitting element, a push button for turning the light-emitting element on and off, and a timer for turning the light-emitting element off after a predetermined amount of time.

In another embodiment, the body comprises a front portion and a rear portion. Additionally, the front portion can comprise a first opening and the rear portion can comprise a second opening.

In another embodiment, the power source comprises one or more lithium ion batteries. Additionally, the circuit board comprises a front surface and a rear surface. Moreover, the light-emitting element can be coupled to the front surface of the circuit board. The light-emitting element can comprise one or more light-emitting diodes.

In another embodiment, the device further comprises an optical lens, and the optical lens can be made from polycarbonate. Additionally, the optical lens can be located inside the first opening, in front of the light-emitting element.

In another embodiment, the audio plug can comprise a cone body, a middle portion, and a rear end portion. The dimmer switch can be coupled to the rear surface of the circuit board, between the circuit board and the push button.

In another embodiment, the device can further comprise a push button cover which is located inside the second opening of the rear portion of the body. Optionally, the predetermined amount of time the timer is set for can be 15 seconds.

According to another embodiment of the present invention, there is provided a system for taking photographs, the system comprising an audio jack coupled light-emitting device comprising a body comprising a front portion and a rear portion, a power source located inside the body, a circuit board comprising a front surface and a rear surface, wherein the circuit board is located inside the body, a light-emitting element coupled to the circuit board, an optical lens located between the front portion of the body and the light-emitting element, an audio plug comprising a cone body, a connector, and a joint portion, a dimming switch coupled to the rear surface of the circuit board and the light-emitting element, a push button for turning the light-emitting element on and off, and a timer for turning the light-emitting element off after a predetermined amount of time, and a smartphone comprising an audio jack.

According to another embodiment of the present invention, there is provided a method of using the audio jack coupled light-emitting device. The method comprises the steps of providing an electronic product comprising an audio jack, inserting the audio plug of the audio jack coupled light-emitting device into the audio jack of the electronic product, pressing the push button cover to press the push button to turn on the light-emitting element, and taking a photograph.

### BRIEF DESCRIPTION OF THE DRAWINGS

These and other features, aspects and advantages of the present invention will become better understood with reference to the following description, appended claims, and accompanying drawings where:

FIG. 1 is a diagram of an exploded front view of an audio jack coupled light-emitting device, having features of the present invention;

FIG. 2 is a diagram of an exploded rear view of the audio jack coupled light-emitting device as shown in FIG. 1;

FIG. 3A is a diagram of the front of the audio jack coupled light-emitting device as shown in FIG. 1, wherein the front portion and the rear portion of the body are coupled together;

FIG. 3B is a diagram of the back of the audio jack coupled light-emitting device as shown in FIG. 1, wherein the front portion and the rear portion of the body are coupled together;

FIG. 4 is a diagram of the audio jack coupled light-emitting device as shown in FIG. 1, wherein the audio jack light source device is coupled to a smartphone;

FIG. 5-1 is a diagram of the internal electronics of the audio jack coupled light-emitting device as shown in FIG. 1; and

FIG. 5-2 is a continuation of the diagram of FIG. 5-1 of the internal electronics of the audio jack coupled light-emitting device as shown in FIG. 1.

### DETAILED DESCRIPTION

### Definitions

As used herein, the following terms and variations thereof have the meanings given below, unless a different meaning is clearly intended by the contest in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers ingredients or steps.

The following discussion describes in detail one embodiment of the invention and several variations of that embodiment. This discussion should not be construed, however, as limiting the invention to those particular embodiments. Practitioners skilled in the art will recognize numerous other embodiments as well.

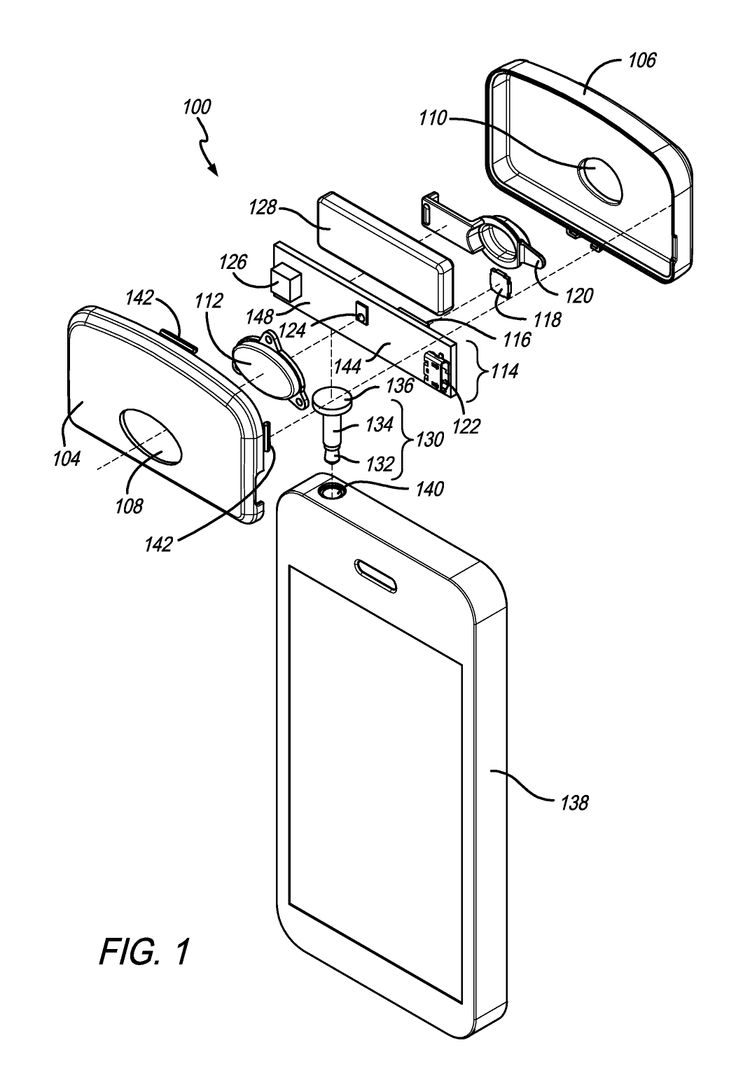

Referring now to FIGS. 1-3, the invention comprises an audio jack coupled light-emitting device 100 comprising a body 102, a power source 128, a light-emitting element 124, an optical lens 112, an audio plug 130, a circuit board 114 containing a timer 148, a charging port 122, a push button 118 for turning the light-emitting element 124 on and off, and a dimmer switch 116. The audio jack coupled light-emitting device 100 can used with any electronic product, including but not limited to a tablet, videogame console, laptop, desktop computer, cell phone or smartphone. The audio jack coupled light-emitting device 100 can be coupled to an electronic product via any mechanical means and via any port in the electronic product. In one embodiment of the invention, the audio jack coupled light-emitting device 100 is coupled to the electronic product via an audio jack in the electronic product 140. For the purposes of discussion, the audio jack coupled light-emitting device 100 can be coupled to a smartphone 138, as shown in FIGS. 1, 2 and 4.

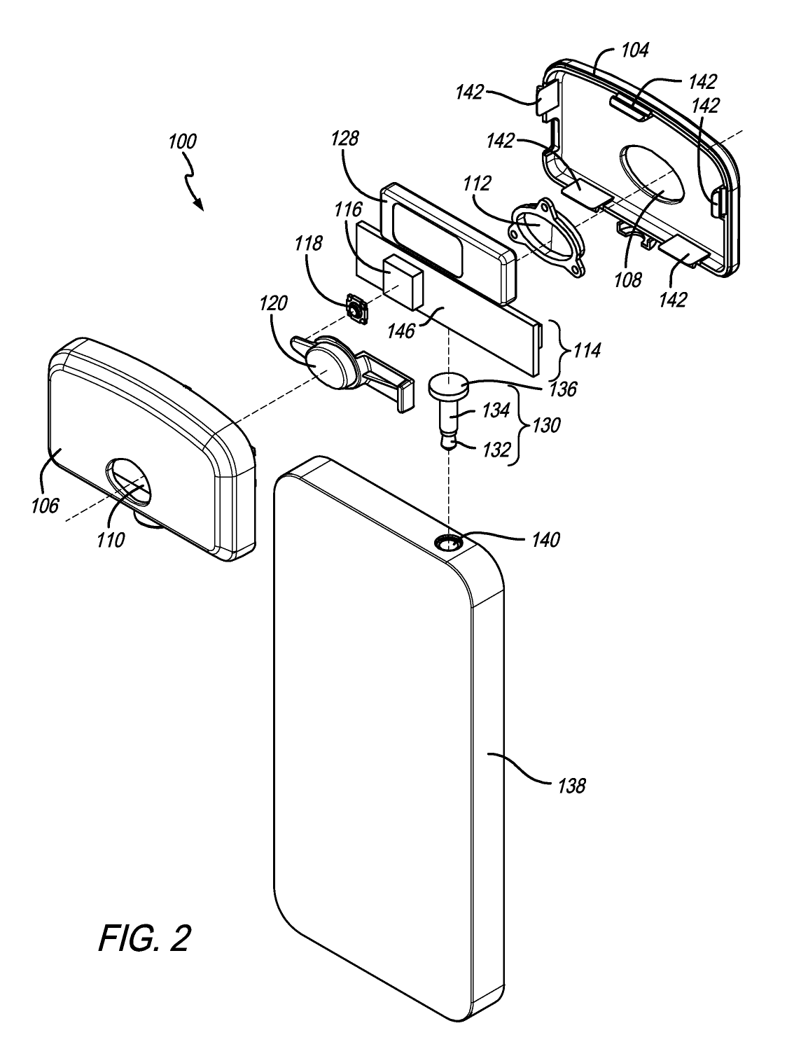

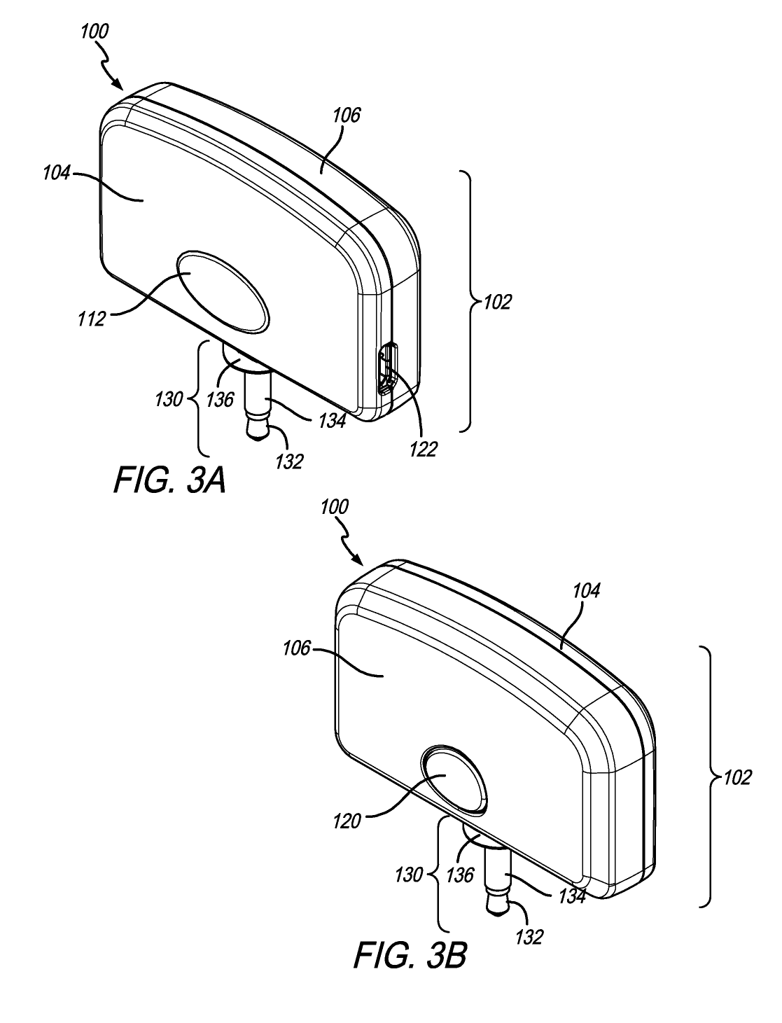

As shown in FIGS. 1-3, the body 102 can comprise a front portion 104 and a rear portion 106, which are removably coupled together. FIG. 1 is an exploded front view of the audio jack coupled light-emitting device 100, and FIG. 2 is an exploded rear view of the audio jack coupled light-emitting device 100. The front portion 104 and the rear portion 106 can be removably coupled together by any means, and any combination of means, including but not limited to friction, a snapping mechanism, a screw mechanism, or one or more connectors 142. Preferably the front portion 104 and the rear portion 106 are removably coupled together by one or more connectors 142, as shown in FIGS. 1 and 2. FIG. 3A is a front view of the audio jack coupled light-emitting device 100, and FIG. 3B is a rear view of the device, wherein the front portion 104 is coupled to the rear portion 106.

Additionally, the front portion 104 can comprise a first opening 108, and the rear portion 106 can comprise a second opening 110. The body 102 can be any shape, including but not limited to square, rectangular, oval, and circular. The body 102 can be any size and dimension, but preferably is approximately 35 millimeters in length, 30 millimeters in height, and 12 millimeters in width. The body 102 can be made from any material, including but not limited to plastic, metal, wood, carbon fiber or fiberglass. Preferably the body 102 is made from a plastic material. Optionally, the body 102 can be made from a transparent or semi-transparent material, so that the interior components can either be partially visible or completely visible to a user.

The power source 128 can comprise any form of compact, portable power source, including but not limited to one or more alkaline batteries, lithium batteries, nickel metal hydride batteries, or lithium-ion batteries. Preferably the audio jack coupled light-emitting device 100 has an internal, independent power source 128 that can be rechargeable and comprises one or more rechargeable lithium-ion batteries. The power source 128 can be any size, shape and dimension, but preferably is approximately 35 millimeters in length, 12 millimeters in height, and 4 millimeters in width. It is beneficial for the audio jack coupled light-emitting device 100 to have its own independent power source because then audio jack coupled light-emitting device 100 does not drain the battery of the electronic product it is coupled to. Optionally, the power source 128 can comprise the electronic product itself, and power can be drawn through the audio plug 130.

Additionally, the audio jack coupled light-emitting device 100 can further comprise one or more charging ports 122 which allow the user to connect the audio jack coupled light-emitting device 100 to any external power source, and charge the power source 128. The one or more charging ports 122 can be any size, shape and dimension, but preferably comprise a micro-USB 5 volt input.

Optionally, the audio jack coupled light-emitting device 100 can further comprise a kinetic motion circuit 126 which allows the audio jack coupled light-emitting device 100 to self-charge using the motion of the user's body. The kinetic motion circuit 126 captures kinetic energy produced by movement, and uses it to charge the power source 128. This is advantageous because the user does not have to wait for the audio jack coupled light-emitting device 100 to charge, as the audio jack coupled light-emitting device 100 is constantly charging and maintaining its charge while it is being used.

The light-emitting element 124 can be any form of light-emitting device, and can comprise a light-emitting diode (LED) or a liquid crystal display (LCD). Preferably the light-emitting element 124 comprises an LED.

The optical lens 112 within the body 102 is located in front of the light-emitting element 124. The optical lens 112 fits inside the first opening 108 of the front portion 104 of the body 102. The first opening 108 can be any shape and size, but preferably is complimentary to the shape and size of the optical lens 112. The optical lens 112 projects the light emitted from the light-emitting element 124 out of the audio jack coupled light-emitting device 100 for use by the user. The optical lens 112 can be any shape and any dimension. Additionally, the optical lens 112 can be made from any material, including but not limited to plastic or glass. Preferably the optical lens 112 is made from a transparent or semi-transparent polycarbonate plastic. The optical lens 112 provides a 120 degree viewing angle.

The audio plug 130 can be any shape and dimension. But preferably, the audio plug 130 comprises a cone body 132, a middle portion 134, and a rear end portion 136. The rear end portion 136 can be coupled to the body 102, providing support for the body 102 as well as securely coupling the audio jack coupled light-emitting device 100 to the electronic product. Different electronic products can have different sized audio jacks, the most common sizes being 2.5 mm and 3 mm. Therefore, the outer diameter of the audio plug 130 can be any size, but preferably is about 1 mm to about 10 mm.

Additionally, the audio jack coupled light-emitting device 100 can comprise one or more circuit boards 114, which control all of the functions of the audio jack coupled light-emitting device 100. The circuit board 114 can have a front surface 144 which faces the front portion 104 of the audio jack coupled light-emitting device 100, and a rear surface 146 which faces the rear portion 106 of the audio jack coupled light-emitting device 100.

Optionally, the circuit board 114 can comprise a timer 148 which turns the light-emitting element 124 off after a predetermined amount of time. The predetermined amount of time can be any length, but preferably comprises 15 seconds.

Additionally, the audio jack coupled light-emitting device 100 can further comprise a push button 118 for turning the light-emitting element 124 on and off. The push button 118 can also be used to select different levels of brightness of the light-emitting element 124. The push button 118 can be located on any surface of the circuit board 114, but preferably is located on the rear surface 146 of the circuit board 114. Additionally, a push button cover 120 can be located between the push button 118 and the rear portion 106 of the audio jack coupled light-emitting device 100. Preferably, the push button cover 120 fits inside the second opening 110 of the rear portion 106. The second opening 110 can be any shape and size, but preferably is complimentary to the shape and size of the push button cover 120. When the user desires to turn on the light-emitting element 124, they press the push button cover 120, which will in turn press the push button 118, which will turn the light-emitting element 124 on. When the user is finished using the audio jack coupled light-emitting device 100, they can press the push button cover 120 and the light-emitting element 124 will turn off.

Optionally, the audio jack coupled light-emitting device 100 can further comprise a dimmer switch 116 that allows the user to select different levels of brightness of the light-emitting element 124. The dimmer switch 116 can comprise any form of voltage reducing technology, but preferably comprises an adjustable resistor. The dimmer switch 116 can be located anywhere on the circuit board 114, but preferably is located between the circuit board 114 and the push button 118. Therefore, when the user presses the push button cover 120, which in turn presses the push button 118, which in turn activates the dimmer switch 116, the user will be able to select different levels of light brightness.

Users can use the audio jack coupled light-emitting device 100 in many different environments, and the ambient light level can differ greatly between different environments. As such, it is desirable for the audio jack coupled light-emitting device 100 to have different selectable levels of brightness, so that the user can achieve the optimum light level desired for any environment they are in. The audio jack coupled light-emitting device 100 can have one or more different level of brightness, but preferably it has four different levels. The different levels of brightness can comprise any percentage of light brightness, but preferably the first level is 25% brightness, the second level is 50% brightness, the third level is 75% brightness and the fourth level is 100% brightness. Thus, when the user presses the push button cover 120, which presses the push button 118, which in turn activates the dimmer switch 116, the light-emitting element 124 will turn on, at its first level of brightness, which is 25%. If the user desires more light, the user presses the push button cover 120 again, which instructs the dimmer switch 116 to progress to the second level of brightness. The light-emitting element 124 is then at 50%. Pressing the push button cover 120 a third time will instruct the dimmer switch 116 to progress to the third level of brightness, increasing the light-emitting element 124 to 75% brightness, and pressing the push button cover 120 a fourth time will instruct the dimmer switch 116 to progress to the fourth level of brightness, increasing the light-emitting element 124 to 100% brightness. If the user desires to turn the light-emitting element 124 off, they simply press the push button cover 120 a fifth time.

Optionally, the audio jack coupled light-emitting device 100 can be coupled to the electronic product by a connector (not shown). The connector can be rigid or flexible, made from any material, including plastic or metal. Additionally, the connector can be any length and dimension. Coupling the audio jack coupled light-emitting device 100 to the connector allows the user to experiment with different lighting positions while taking their photos. For example, some smartphones now have their audio jack 140 located at the bottom of the smartphone 138, while the camera remains at the top. The bottom of the smartphone 138 is usually not the ideal place for the light source while taking photos. Thus, having the light source coupled to a flexible connector allows the user to use the audio jack coupled light-emitting device 100 in combination with any other electronic product, regardless of the audio jack 140 placement.

Optionally, the audio jack coupled light-emitting device 100 can be operated by an application (not shown) installed on the electronic product. The application can be used to set different levels of brightness other than the four levels originally provided with the audio jack coupled light-emitting device 100. The application can also be used to turn the audio jack coupled light-emitting device 100 on and off, and can also allow the user to change the length of the timer 148.

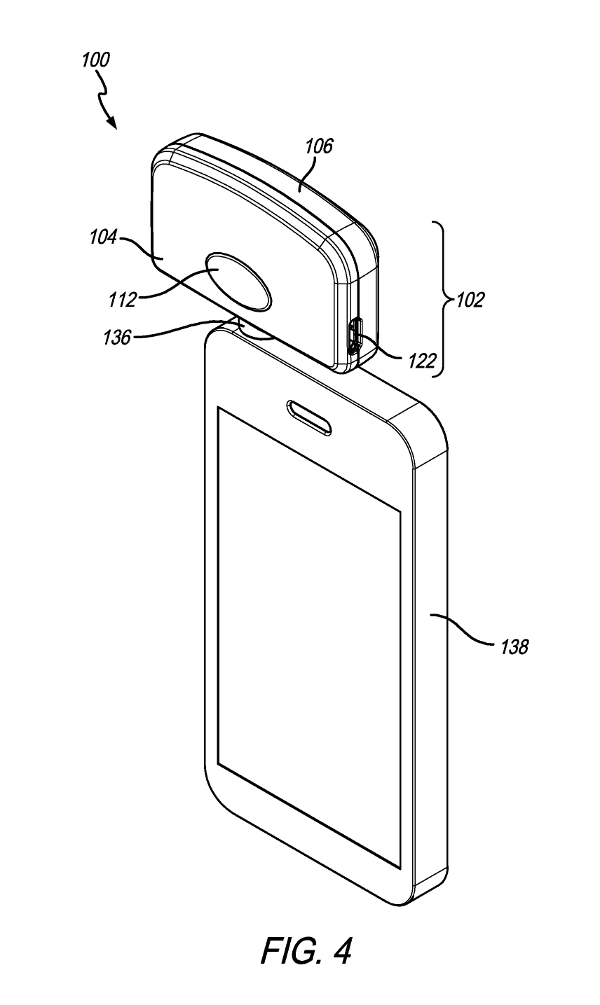

As shown in FIG. 4, in use, the audio jack coupled light-emitting device 100 is coupled to an electronic product by inserting the audio plug 130 into the audio jack 140 of the smartphone 138. Once installed, the user presses the push button cover 120 to turn the light-emitting element 124 on, holds the smartphone 138 in the desired position, and takes a photo.

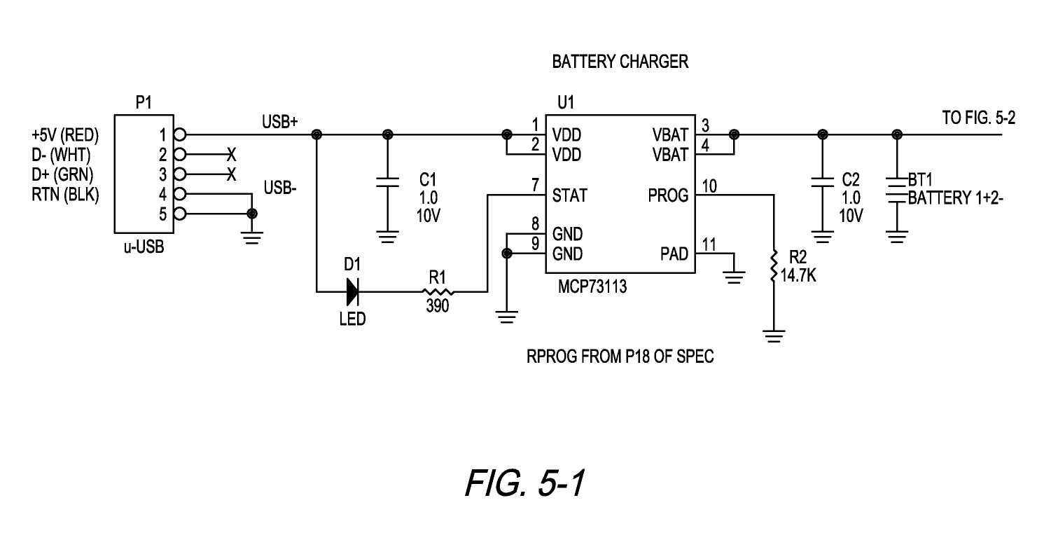

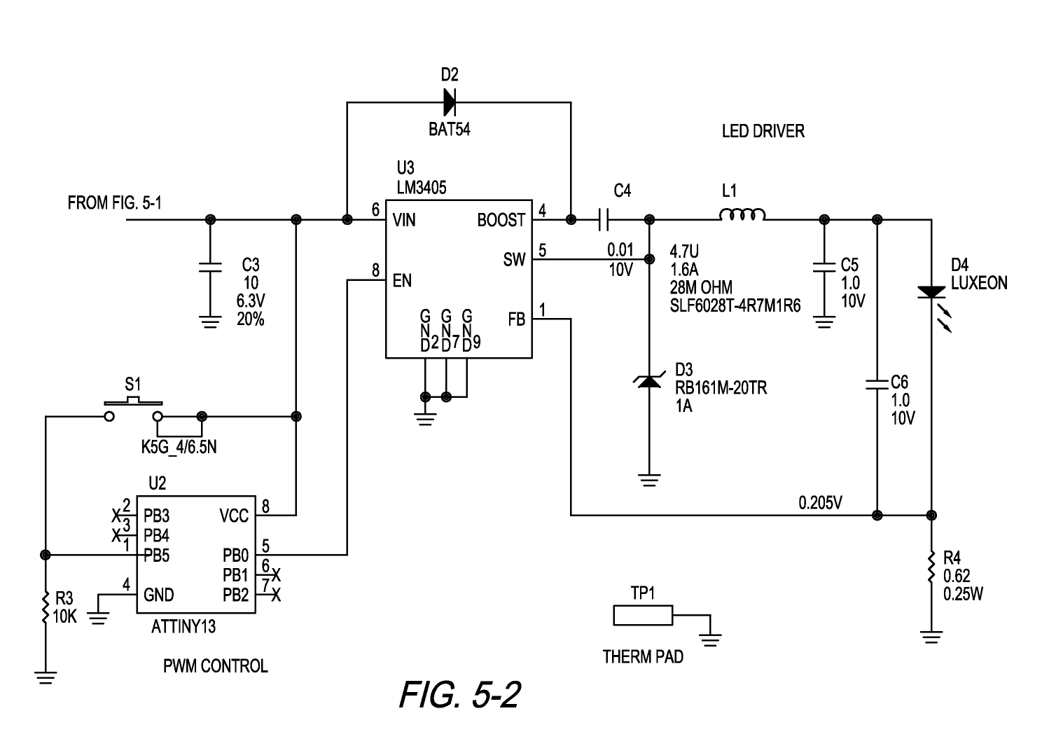

Referring now to FIGS. 5-1 and 5-2, there are shown a representations of the internal electronics of the audio jack coupled light-emitting device 100 of FIG. 1.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

What is claimed is:

1. An audio jack coupled light-emitting device comprising:
a) a body comprising a front portion and a rear portion, wherein the front portion comprises a first opening and the rear portion comprises a second opening;
b) a power source located inside the body, the power source comprising one or more lithium ion batteries;
c) a circuit board comprising a front surface and a rear surface, wherein the circuit board is located inside the body;
d) a light-emitting element coupled to the front surface of the circuit board;
e) an optical lens inside the first opening in the front portion of the body, in front of the light-emitting element;
f) an audio plug comprising a cone body, a middle portion, and a rear end portion;
g) a dimmer switch coupled to the rear surface of the circuit board and the light-emitting element;
h) a push button for turning the light-emitting element on and off;
i) a push button cover for triggering the push button; and
j) a timer for turning the light-emitting element off after a predetermined amount of time.

2. An audio jack coupled light-emitting device comprising:
a) a body;
b) a power source located inside the body;
c) a circuit board located inside the body;
d) a light-emitting element coupled to the circuit board;
e) an audio plug coupled to the body;
f) a dimmer switch coupled to the circuit board and the light-emitting element;
g) a push button for turning the light-emitting element on and off; and
h) a timer for turning the light-emitting element off after a predetermined amount of time.

3. The device of claim 2, wherein the body comprises a front portion and a rear portion.

4. The device of claim 3, wherein the front portion comprises a first opening and the rear portion comprises a second opening.

5. The device of claim 2, wherein the power source comprises one or more lithium ion batteries.

6. The device of claim 2, wherein the circuit board comprises a front surface and a rear surface.

7. The device of claim 6, wherein the light-emitting element is coupled to the front surface of the circuit board.

8. The device of claim 2, wherein the light-emitting element comprises one or more light-emitting diodes.

9. The device of claim 4, further comprising an optical lens.

10. The device of claim 9, wherein the optical lens is made from polycarbonate.

11. The device of claim 9, wherein the optical lens is located inside the first opening, in front of the light-emitting element.

12. The device of claim 2, wherein the audio plug comprises a cone body, a middle portion, and a rear end portion.

13. The device of claim 6, wherein the dimmer switch is coupled to the rear surface of the circuit board, between the circuit board and the push button.

14. The device of claim 4, further comprising a push button cover which is located inside the second opening of the rear portion of the body.

15. The device of claim 2, wherein the predetermined amount of time is 15 seconds.

16. A system for taking photographs, the system comprising:
a) an audio jack coupled light-emitting device comprising:
i) a body comprising a front portion and a rear portion;
ii) a power source located inside the body;
iii) a circuit board comprising a front surface and a rear surface, wherein the circuit board is located inside the body;
iv) a light-emitting element coupled to the circuit board;
v) an optical lens located between the front portion of the body and the light-emitting element;
vi) an audio plug comprising a cone body, a connector, and a joint portion;
vii) a dimming switch coupled to the rear surface of the circuit board and the light-emitting element;
viii) a push button for turning the light-emitting element on and off; and
ix) a timer for turning the light-emitting element off after a predetermined amount of time; and
b) a smartphone comprising an audio jack.

17. A method of using the device of claim 1, the method comprising the steps of:
a) providing an electronic product comprising an audio jack;
b) inserting the audio plug of the audio jack coupled light-emitting device into the audio jack of the electronic product;
c) pressing the push button cover to press the push button to turn on the light-emitting element; and
d) taking a photograph.
